(19) United States
(12) Patent Application Publication
(10) Pub. No.: US 2025/0225668 A1
(43) Pub. Date: Jul. 10, 2025

(54) SEMANTIC CHARACTERISTICS FOR SCALE ESTIMATION WITH MONOCULAR DEPTH ESTIMATION

(71) Applicant: Toyota Research Institute, Inc., Los Altos, CA (US)

(72) Inventor: Vitor Campagnolo Guizilini, Santa Clara, CA (US)

(73) Assignees: Toyota Research Institute, Inc., Los Altos, CA (US); Toyota Jidosha Kabushiki Kaisha, Toyota-shi Aichi-ken (JP)

(21) Appl. No.: 18/406,545

(22) Filed: Jan. 8, 2024

(51) Int. Cl. G06T 7/50; G06T 7/12; G06T 7/62; G06V 10/46; G06V 10/764

(52) U.S. Cl. CPC G06T 7/50; G06T 7/12; G06T 7/62; G06V 10/462; G06V 10/764

(57) ABSTRACT

Systems, methods, and other embodiments described herein relate to using salient features to improve scale awareness in a depth model. In one embodiment, a method includes acquiring an image depicting surrounding objects present in an environment. The method includes selecting a salient object from the surrounding objects. The method includes determining characteristics of the salient object according to a language model. The method includes adapting a depth model according to the characteristics.

### TECHNICAL FIELD

The subject matter described herein relates, in general, to systems and methods for deriving scaling factors from semantic information about a scene to adapt a depth model and, more particularly, to using a language model to extract characteristics of objects from a scene in order to improve the depth model.

### BACKGROUND

Various devices that operate autonomously or that provide information about a surrounding environment use sensors that facilitate perceiving obstacles and additional aspects of the surrounding environment. For example, a robotic device may use information from the sensors to develop an awareness of the surrounding environment in order to navigate through the environment. In particular, the robotic device uses the perceived information to determine a 3-D structure of the environment in order to identify navigable regions and avoid potential hazards.

The ability to perceive distances through the estimation of depth using sensor data provides the robotic device with the ability to plan movements through the environment and generally improve situational awareness about the environment. However, depending on the available onboard sensors, the robotic device may acquire a limited perspective of the environment and, thus, encounter difficulties in distinguishing aspects of the environment.

For example, while monocular cameras can be a cost-effective approach to acquiring information about the surroundings, the sensor data from such cameras does not explicitly include depth information. Instead, processing routines derive depth information from the monocular images. However, leveraging monocular images to perceive depth can suffer from various difficulties, such as a lack of scale awareness. That is, while the depth model may generate depth information from the monocular image alone, the depth information is generally relative and is adapted according to an estimated scaling factor. Accordingly, the depth model can accurately learn relative depth; however, the depth model may not learn depth information that is accurate to the appropriate metric scale, thereby resulting in estimations of depth information that can be inaccurate.

### SUMMARY

Example systems and methods relate to using salient features to improve scale awareness in a depth model. As noted previously, training a depth model using a self-supervised approach may result in relatively accurate depth estimations, which lack awareness of scale. That is, estimates of depth relative to sizes of depicted objects are generally accurate but do not specifically portray an accurate metric scale. This may result from a lack of information about metric scale available within the training data itself (i.e., the raw images). Accordingly, in at least one arrangement, a depth system is disclosed that implements a novel approach to integrating awareness of scale, thereby improving a resulting depth map and avoiding difficulties with inaccurate representations.

For example, in one approach, the depth system implements an additional layer of processing beyond estimating depth for an image. In particular, the depth system leverages a language model, such as a large language model (LLM) or a visual language model (VLM), to determine the characteristics of salient objects in the scene depicted by an image. In one arrangement, the depth system acquires the image, which may be for purposes of training the depth model or may be for analysis during inference. In either case, the image is a monocular image of an environment around the acquiring device (e.g., a vehicle with a monocular camera). Thus, the depth system may initially process the image to determine the characteristics of one or more salient objects depicted in the image. That is, the depth system discriminates between different objects depicted in the image to select salient objects for which characteristics are known or can otherwise be determined. For example, an object such as a stop sign has dimensions that are generally standard and known. Similarly, vehicles of a particular make/model/year also have known dimensions. By contrast, trees, buildings, animals, etc., are not standardized and, thus, do not have easily determinable sizes. Thus, the depth system selects the salient objects to focus the analysis.

In one approach, the depth system processes the image using a semantic model that identifies classifications for the objects present in the image via, for example, semantic segmentation. From the classifications of the objects, the system selects one or more salient objects depicted in the image. The depth system can then feed the salient objects to an LLM. In one approach, the LLM accepts, for example, the semantic labels of the salient objects and provides the characteristics (e.g., physical dimensions) as a result. In a further approach, the depth system may segment the salient objects and provide the visual representation along with the classifications. In this way, the depth system is leveraging the LLM to determine the characteristics from which the depth system can then derive a scaling factor that defines, for example, a ratio for adjusting the depth values of a corresponding depth map. The depth map is a representation of depth values within the image on a per-pixel basis in relation to the camera that captured the image. Thus, in parallel, the depth system can use the depth model, which performs monocular depth estimation, to generate the depth map from the monocular image.

Thereafter, the system can use the scaling factor in multiple different ways. If the depth system is training the depth model according to a self-supervised approach, then the depth system can use the scaling factor as an additional element within a loss function for adapting the depth model and thereby train the depth model on an accurate metric scale. When used during inference, the depth system can use the scaling factor to adjust values generated by the depth model as, for example, a mechanism for calibrating the depth model or otherwise maintaining accuracy. In either case, the depth system improves the accuracy of the depth model by leveraging information acquired via the language model, thereby improving the functioning of associated systems according to the improved perceptions.

In one embodiment, a depth system is disclosed. The depth system includes one or more processors and a memory communicably coupled to the one or more processors. The memory stores instructions that, when executed by the one or more processors, cause the one or more processors to acquire an image depicting surrounding objects present in an environment. The instructions include instructions to select a salient object from the surrounding objects, and to determine characteristics of the salient object according to a language model. The instructions include instructions to adapt a depth model according to the characteristics.

In one embodiment, a non-transitory computer-readable medium including instructions that, when executed by one or more processors, cause the one or more processors to perform various functions is disclosed. The instructions include instructions to acquire an image depicting surrounding objects present in an environment. The instructions include instructions to select a salient object from the surrounding objects. The instructions include instructions to determine characteristics of the salient object according to a language model, and to adapt a depth model according to the characteristics.

In one embodiment, a method is disclosed. In one embodiment, the method includes acquiring an image depicting surrounding objects present in an environment. The method includes selecting a salient object from the surrounding objects. The method includes determining characteristics of the salient object according to a language model. The method includes adapting a depth model according to the characteristics.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle within which systems and methods disclosed herein may be implemented.

FIG. 2 illustrates one embodiment of a depth system that is associated with deriving a scaling factor.

FIG. 3 illustrates one embodiment of a depth model that infers depth from a monocular image.

FIG. 4 illustrates one embodiment of a pose model that predicts rigid transformations of a pose between images.

FIG. 5 illustrates a scaling pipeline implemented by a depth system.

FIG. 6 is a flowchart illustrating one embodiment of a method for adapting a depth model according to a scaling factor.

FIG. 7 illustrates an example scene depicted by an image.

### DETAILED DESCRIPTION

Systems, methods, and other embodiments associated with using salient features to improve scale awareness in a depth model are disclosed. As noted previously, training a depth model using a self-supervised approach may result in relatively accurate depth estimations; however, the estimates can lack awareness of scale. That is, estimates of depth relative to sizes of depicted objects are generally accurate but do not specifically portray an accurate metric scale. This may result from a lack of information about metric scale available within the training data itself (i.e., the raw images). Accordingly, in at least one arrangement, a depth system is disclosed that implements a novel approach to integrating awareness of scale, thereby improving a resulting depth map and avoiding difficulties with inaccurate representations.

For example, in one approach, the depth system implements an additional layer of processing beyond estimating depth for an image. In particular, the depth system leverages a language model, such as a large language model (LLM) or a visual language model (VLM), to determine characteristics of salient objects in the scene depicted by an image. In one arrangement, the depth system acquires the image, which may be for purposes of training the depth model or may be for analysis during inference. In either case, the image is a monocular image of an environment around the acquiring device (e.g., a vehicle with a monocular camera). Thus, the depth system may initially process the image to determine characteristics of one or more salient objects depicted in the image. That is, the depth system discriminates between different objects depicted in the image to select salient objects for which characteristics are known or can otherwise be determined. For example, an object such as a stop sign has dimensions that are generally standard and known. Similarly, vehicles of a particular make/model/year also have known dimensions. By contrast, trees, buildings, animals, etc. are not standardized and, thus, do not have easily determinable sizes. Thus, the depth system selects the salient objects to focus the analysis.

In one approach, the depth system processes the image using a semantic model that identifies classifications for the objects present in the image via, for example, semantic segmentation. From the classifications of the objects, the system selects one or more salient objects depicted in the image. The depth system can then feed the salient objects to an LLM. In one approach, the LLM accepts, for example, the semantic labels of the salient objects and provides the characteristics (e.g., physical dimensions) as a result. In a further approach, the depth system may segment the salient objects and provide the visual representation along with the classifications. In this way, the depth system is leveraging the LLM to determine the characteristics from which the depth system can then derive a scaling factor that defines, for example, a ratio for adjusting the depth values of a corresponding depth map. The depth map is a representation of depth values within the image on a per-pixel basis in relation to the camera that captured the image. Thus, in parallel, the depth system can use the depth model, which performs monocular depth estimation, to generate the depth map from the monocular image.

Thereafter, the system can use the scaling factor in multiple different ways. If the depth system is training the depth model according to a self-supervised approach, then the depth system can use the scaling factor as an additional element within a loss function for adapting the depth model and thereby train the depth model on accurate metric scale. When used during inference, the depth system can use the scaling factor to adjust values generated by the depth model as, for example, a mechanism for calibrating the depth model or otherwise maintaining accuracy. In either case, the depth system improves the accuracy of the depth model by leveraging information acquired via the language model, thereby improving the functioning of associated systems according to the improved perceptions.

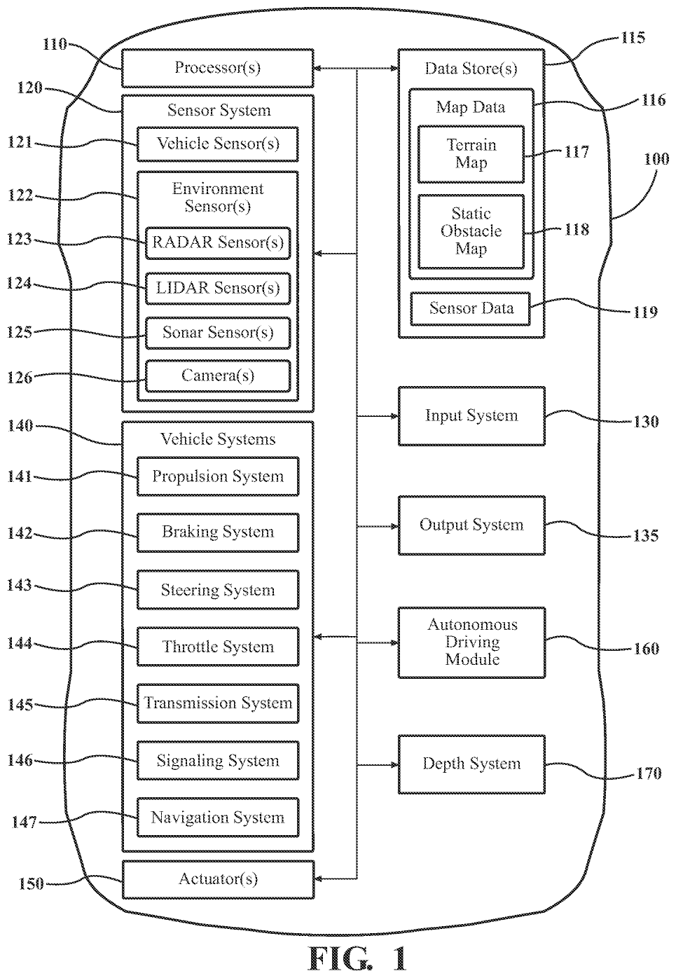

Referring to FIG. 1, an example of a vehicle 100 is illustrated. As used herein, a “vehicle” is any form of powered transport. In one or more implementations, the vehicle 100 is an automobile. While arrangements will be described herein with respect to automobiles, it will be understood that embodiments are not limited to automobiles. In some implementations, the vehicle 100 may be any electronic device (e.g., smartphone, surveillance camera, robot, etc.) that, for example, perceives an environment according to monocular images, and thus benefits from the functionality discussed herein. In yet further embodiments, the vehicle 100 may instead be a statically mounted device, an embedded device, or another device that uses monocular images to derive depth information about a scene or that separately trains the depth model for deployment in such a device.

In any case, the vehicle 100 (or another electronic device) also includes various elements. It will be understood that, in various embodiments, it may not be necessary for the vehicle 100 to have all of the elements shown in FIG. 1. The vehicle 100 can have a different combination of the various elements shown in FIG. 1. Further, the vehicle 100 can have additional elements to those shown in FIG. 1. In some arrangements, the vehicle 100 may be implemented without one or more of the elements shown in FIG. 1. While the various elements are illustrated as being located within the vehicle 100, it will be understood that one or more of these elements can be located external to the vehicle 100. Further, the elements shown may be physically separated by large distances and provided as remote services (e.g., cloud-computing services, software-as-a-service (SaaS), distributed computing service, etc.).

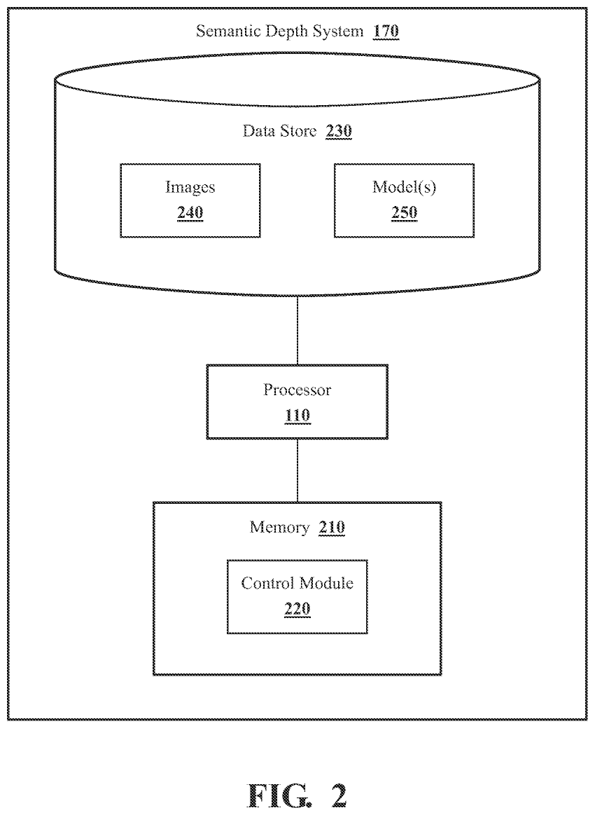

Some of the possible elements of the vehicle 100 are shown in FIG. 1 and will be described along with subsequent figures. However, a description of many of the elements in FIG. 1 will be provided after the discussion of FIGS. 2-7 for purposes of the brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements.

In any case, the vehicle 100 includes a depth system 170 that functions to train and implement a model to process monocular images and provide depth estimates for an environment (e.g., objects, surfaces, etc.) depicted therein. Moreover, while depicted as a standalone component, in one or more embodiments, the depth system 170 is integrated with the automated driving module 160, the camera 126, or another component of the vehicle 100. The noted functions and methods will become more apparent with a further discussion of the figures.

With reference to FIG. 2, one embodiment of the depth system 170 is further illustrated. The depth system 170 is shown as including a processor 110. Accordingly, the processor 110 may be a part of the depth system 170 or the depth system 170 may access the processor 110 through a data bus or another communication path. In one or more embodiments, the processor 110 is an application-specific integrated circuit (ASIC) that is configured to implement functions associated with a control module 220. In general, the processor 110 is an electronic processor, such as a microprocessor, that is capable of performing various functions, as described herein. In one embodiment, the depth system 170 includes a memory 210 that stores the control module 220. The memory 210 is a random-access memory (RAM), read-only memory (ROM), a hard disk drive, a flash memory, or other suitable memory for storing the control module 220. The control module 220 is, for example, computer-readable instructions that, when executed by the processor 110, cause the processor 110 to perform the various functions disclosed herein.

Furthermore, in one embodiment, the depth system 170 includes a data store 230. The data store 230 is, in one embodiment, an electronic data structure, such as a database, that is stored in the memory 210 or another memory, and that is configured with routines that can be executed by the processor 110 for analyzing stored data, providing stored data, organizing stored data, and so on. Thus, in one embodiment, the data store 230 stores data used by the control module 220 in executing various functions. In one embodiment, the data store 230 includes images 240, and models 250, which may include a depth model, a pose model, a language model, such as a large language model or a visual language model, and/or a semantic model, along with, for example, other information that is used by the control module 220.

Training data used by the depth system 170 generally includes one or more monocular videos that are comprised of a plurality of frames in the form of the images 240 that are monocular images. Of course, the images 240 may alternatively be input images for use during inference by the depth model. As described herein, a monocular image is, for example, an image from the camera 126, or another monocular camera, that may be part of a video, and that encompasses a field-of-view (FOV) about the vehicle 100 of at least a portion of the surrounding environment. That is, the monocular image is, in one approach, generally limited to a subregion of the surrounding environment. As such, the image may be of a forward-facing (i.e., the direction of travel) 60, 90, 120-degree FOV, a rear/side facing FOV, or some other subregion as defined by the characteristics of the camera 126.

In any case, the monocular image itself includes visual data of the FOV that is encoded according to a video/image standard (e.g., codec) associated with the camera 126. In general, the characteristics of the camera 126 and a video/image standard define a format of the monocular image. Thus, while the particular characteristics can vary according to different implementations, in general, the image has a defined resolution (i.e., height and width in pixels) and format. Thus, for example, the monocular image is generally an RGB visible light image. Whichever format that the depth system 170 implements, the images 240 are monocular images in that there is no explicit additional modality indicating depth nor an explicit corresponding image from another camera from which the depth can be derived (i.e., no stereo camera pair). In contrast to a stereo image that may integrate left and right images from separate cameras mounted to generate an overlapping FOV to provide an additional depth channel, the monocular image does not include explicit depth information, such as disparity maps derived from comparing the stereo images pixel-by-pixel. Instead, the monocular image implicitly provides depth information in the relationships of perspective and size of elements depicted therein from which the depth model derives the depth maps.

Moreover, the monocular video may include observations of many different scenes. That is, as the camera 126 or another original source camera of the video progresses through an environment, perspectives of objects and features in the environment change, and the depicted objects/features themselves also change, thereby depicting separate scenes (i.e., particular combinations of objects/features). Thus, the depth system 170 may extract particular training sets (e.g., pairs of source and target images) of monocular images from the monocular video for training. In particular, the depth system 170 generates the sets of images from the video so that the sets of images are of the same scene are related through the depiction of the same scene. As should be appreciated, the video includes a series of monocular images that are taken in succession according to a configuration of the camera. Thus, the camera may generate the images 240 (also referred to herein as frames) of the video at regular intervals, such as every 0.033 s. That is, a shutter of the camera operates at a particular rate (i.e., frames-per-second (fps)), which may be, for example, 24 fps, 30 fps, 60 fps, etc.

For purposes of the present discussion, the fps is presumed to be 30 fps. However, it should be appreciated that the fps may vary according to a particular configuration. Moreover, the depth system 170 need not generate the images for training from successive ones (i.e., adjacent) of the frames from the video, but instead can generally include separate images of the same scene that are not successive as training images. Thus, in one approach, the depth system 170 selects every other image depending on the fps. In a further approach, the depth system selects every fifth image as a training pair. The greater the timing difference in the video between the images, the more pronounced a difference in camera position; however, this may also result in fewer shared features/objects between the images. As such, the pairs of training images are of a same scene and are generally constrained, in one or more embodiments, to be within a defined number of frames (e.g., 5 or fewer) to ensure correspondence of an observed scene between the monocular training images. In any case, the pairs of training images generally have the attributes of being monocular images from a monocular video that are separated by some interval of time (e.g., 0.06 s) such that a perspective of the camera changes between the pair of training images as a result of the motion of the camera through the environment while generating the video.

Moreover, while the images 240 are described as training images (i.e., for purposes of adapting the depth model to improve accuracy/understanding), the depth system 170 similarly processes images of the same/similar character after training and during inference to generate the noted outputs (i.e., the depth maps). Thus, during inference and while in use as implemented, the images 240 are instead derived from a monocular camera and may not be associated via a video. Additionally, while the depth model generates a single depth map per image, the pose model accepts inputs of multiple images (e.g., two or more) to produce outputs (i.e., a transformation between image views).

With further reference to FIG. 2, the depth system 170 further includes the models 250, which include the depth model that produces the depth maps, and, in at least one approach, the pose model, which produces transformations of camera pose between the images 240 (i.e., between a source image and a target image). As previously noted, the models 250 may further include a language model and/or a semantic model. The language model, the semantic model, the depth model, and the pose model are, in one embodiment, machine learning algorithms. However, the particular form of the models 250 may be generally distinct. That is, for example, the depth model is a machine learning algorithm that accepts an electronic input in the form of a single monocular image and produces a depth map as a result of processing the monocular image. The exact form of the depth model may vary according to the implementation, but is generally a convolutional encoder-decoder type of neural network.

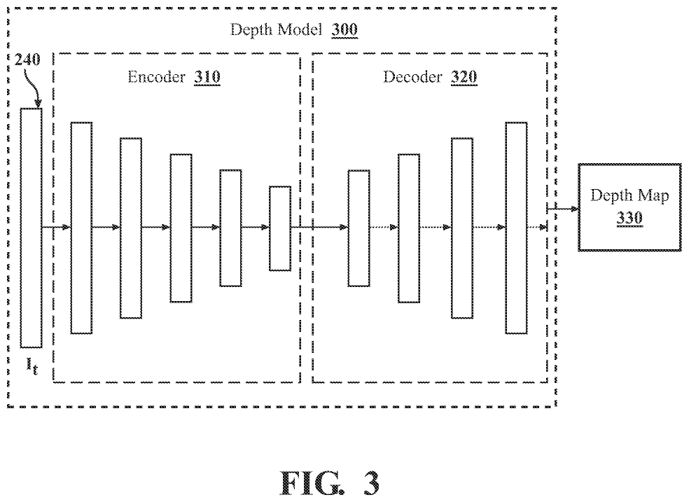

As an additional explanation of one embodiment of the depth model, consider FIG. 3. FIG. 3 illustrates a detailed view of a depth model 300. In one embodiment, the depth model 300 has an encoder/decoder architecture. The encoder/decoder architecture generally includes a set of neural network layers, including convolutional components embodied as an encoder 310 (e.g., 2D and/or 3D convolutional layers forming an encoder) that flow into deconvolutional components embodied as a decoder 320 (e.g., 2D and/or 3D deconvolutional layers forming a decoder). In one approach, the encoder 310 accepts one of the images 240 at a time as an electronic input and processes the image to extract features therefrom. The features are, in general, aspects of the image that are indicative of spatial information that the image intrinsically encodes. As such, encoding layers that form the encoder function to, for example, fold (i.e., adapt dimensions of the feature map to retain the features) encoded features into separate channels, iteratively reducing spatial dimensions of the image while packing additional channels with information about embedded states of the features. Thus, the addition of the extra channels avoids the lossy nature of the encoding process and facilitates the preservation of more information (e.g., feature details) about the original monocular image.

Accordingly, in one embodiment, the encoder 310 is comprised of multiple encoding layers formed from a combination of two-dimensional (2D) convolutional layers, packing blocks, and residual blocks. Moreover, the separate encoding layers generate outputs in the form of encoded feature maps (also referred to as tensors), which the encoding layers provide to subsequent layers in the depth model 300. As such, the encoder 310 includes a variety of separate layers that operate on the monocular image, and subsequently on derived/intermediate feature maps that convert the visual information of the monocular image into embedded state information in the form of encoded features of different channels.

In one embodiment, the decoder 320 unfolds (i.e., adapts dimensions of the tensor to extract the features) the previously encoded spatial information in order to derive the depth map 330 for a given image according to learned correlations associated with the encoded features. That is, the decoding layers generally function to up-sample, through sub-pixel convolutions and/or other mechanisms, the previously encoded features into the depth map 330, which may be provided at different resolutions. In one embodiment, the decoding layers comprise unpacking blocks, two-dimensional convolutional layers, and inverse depth layers that function as output layers for different scales of the feature map. The depth map 330 is, in one embodiment, a data structure corresponding to the input image that indicates distances/depths to objects/features represented therein. Additionally, in one embodiment, the depth map 330 is a tensor with separate data values indicating depths for corresponding locations in the image on a per-pixel basis.

Moreover, the depth model 300 can further include skip connections for providing residual information between the encoder 310 and the decoder 320 to facilitate memory of higher-level features between the separate components. While a particular encoder/decoder architecture is discussed, as previously noted, the depth model 300, in various approaches, may take different forms and generally functions to process the monocular images and provide depth maps that are per-pixel estimates about distances of objects/features depicted in the images.

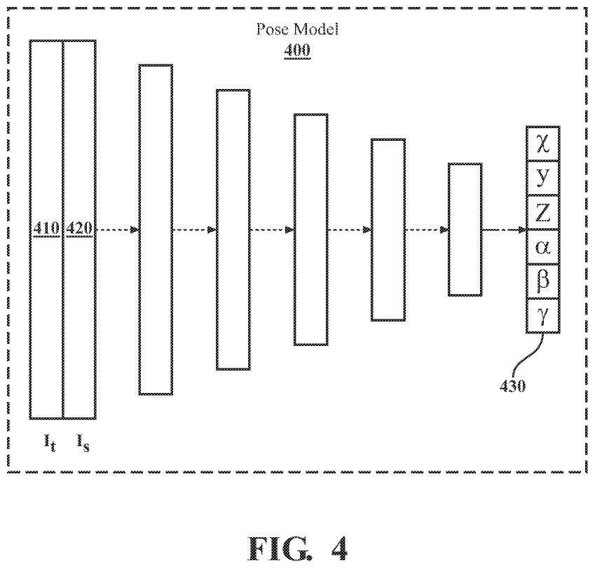

Continuing to FIG. 4, which illustrates a schematic of a pose model 400, the pose model 400 accepts two monocular images (i.e., a source image and a target image) of the same scene as an electronic input and processes the monocular images (Iₜ, Iₛ) 410/420 of the images 240 to produce estimates of camera ego-motion in the form of a set of 6 degree-of-freedom (DOF) transformations 430 between the two images. The pose model 400 itself is, for example, a convolutional neural network (CNN) or another learning model that is differentiable and performs a dimensional reduction of the input images to produce the transformation 430. In one arrangement, the pose model 400 includes 7 stride-2 convolutions, a 1×1 convolution with 6*(N−1) output channels corresponding to 3 Euler angles and a 3-D translation for one of the images (source image Iₛ), and global average pooling to aggregate predictions at all spatial locations. The transformation 430 is, in one embodiment, a 6 DOF rigid-body transformation belonging to the special Euclidean group SE(3) that represents the change in pose between the pair of images provided as inputs to the depth model 300. In any case, the pose model 400 performs a dimensional reduction of the monocular images to derive the transformation 430 therefrom.

While not separately illustrated, reference will now be provided to the language model. The language model is, in at least one approach, a large language model (LLM). The LLM is a deep learning algorithm that performs natural language processing (NLP) tasks, which may be in combination with other tasks. The LLM may be formed from a transformer neural network, such as a generative pre-trained transformer (GPT). In general, the language model accepts at least characteristics of identified objects, which may be provided in the form of textual descriptions along with, for example, a specific query (e.g., what is the size of “x” object), to which the language model provides a textual description as an answer (e.g., 5 m×2 m×1.5 m). In further arrangements, the language model may be a visual language model (VLM), which accepts visual data, such as an image of the object, in addition to the textual description. In any case, the language model generally functions to provide characteristics of objects as requested via an input about one or more salient objects.

Moreover, in one or more arrangements, the depth system 170 further includes a semantic model for extracting semantic information from the images 240. For example, the semantic model is a convolutional neural network (CNN) that processes the images 240 to identify a semantic representation for each pixel depicted therein. The semantic representation includes at least a classification of a type of the object and may further include additional information, such as further identifying details (e.g., vehicle make, model, year, etc.) of the object.

As an additional note, while the models 250 are discussed as discrete units separate from the control module 220, the models 250 are, in one or more arrangements, generally integrated with the control module 220. That is, the control module 220 functions to execute various processes of the models 250 and use various data structures of the models 250 in support of such execution. Accordingly, in one embodiment, the control module 220 includes instructions that function to control the processor 110 to generate the outputs using the models 250.

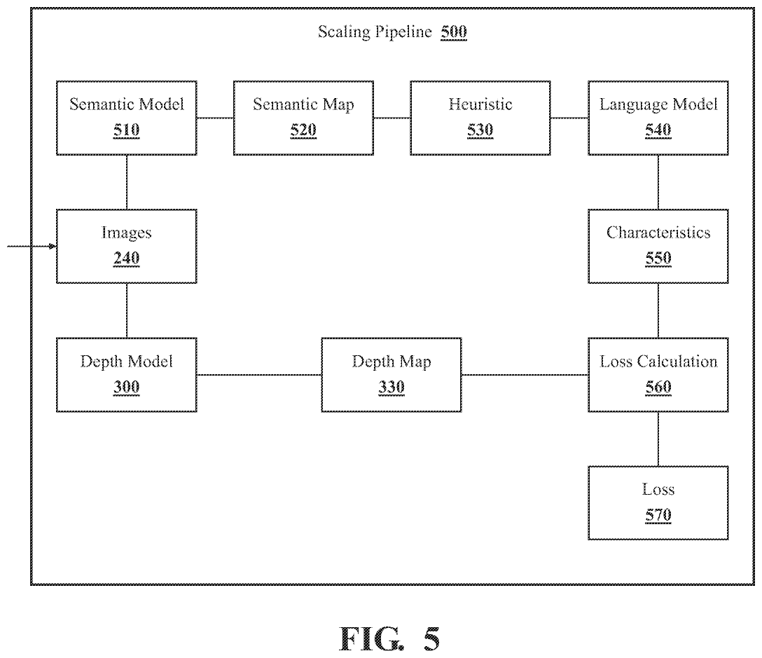

As a brief example of a scaling pipeline 500 implemented with the models 250, consider FIG. 5. FIG. 5 is illustrated from the perspective of training the depth model 300. However, it should be appreciated that the present approach of generating the scaling factor may also be implemented in relation to inference. Moreover, FIG. 5 will be discussed in combination with FIGS. 1-4.

As shown in FIG. 5, the scaling pipeline 500 accepts the images 240 as an input. In general, the scaling pipeline 500, which is, for example, implemented by the control module 220, processes a single image at a time in relation to determining a scaling factor. However, it should be appreciated that aspects relating to self-supervised training will generally involve the use of at least two of the images 240. In any case, a semantic model 510 processes an image to generate a semantic map 520. The semantic map 520 identifies at least classifications of objects depicted within the image. For example, the semantic model 510 is trained to identify a particular ontology or set of objects. The degree of specificity of the classification may vary depending on the implementation but is generally sufficient in order to accurately identify, for example, a type of vehicle, a type of sign, a building, a roadway, and other objects that are generally present within a scene, such as a streetscape whether rural or urban. Moreover, the semantic model 510 generates the semantic map 520 to define an extent of the separate objects as depicted within the scene. Accordingly, the semantic map 520 segments the separate objects such that subsequent components may isolate the salient objects from other surrounding objects.

For example, the scaling pipeline 500 is further illustrated as including a heuristic 530. The heuristic 530, in at least one approach, represents separate logic that functions to analyze the semantic map 520 and select one or more salient objects from the semantic map 520. While illustrated as a separate component in the scaling pipeline 500, the heuristic 530 may instead be native functionality of the language model 540 as may the functionality of the semantic model 510 in further arrangements. In any case, heuristic 530 functions to determine which objects in the semantic map 520 are salient objects. In general, the depth system 170 distinguishes between the separate objects in order to provide objects with discernable features as opposed to classes of objects that have a wide variation in physical features. For example, the salient objects are generally standardized objects, such as roadway signs, vehicles, fire hydrants, or other objects that have known physical dimensions (i.e., height, width, length). This serves to provide reliably identifiable information about the objects that can then be used as a reference for defining the scaling factor.

Accordingly, the control module 220 implements the heuristic 530 to select the salient objects and form the input to the language model 540. The heuristic 530 may form the input by phrasing a query to the language model 540 according to the semantic classification of the salient object. As a simple example, the heuristic 530 may select a stop sign as the salient object and generate the query to recite “what is the size of the stop sign.” The control module 220 then provides the query to the language model and, in at least one approach, may further provide the visual representation of the stop sign along with the query as, for example, a segmented section of the image.

In turn, the language model 540 analyzes the query to determine the characteristics of the salient object. The characteristics define the physical dimensions of the salient object, such as the height, width, and length. In further aspects, the language model 540 may further determine a pose of the object relative to a viewing angle of the camera generating the image. The characteristics permit the control module 220 to determine the scaling factor by utilizing the salient object as a reference point against depth values. That is, the depth model 300 accepts the image as an input and generates a depth map 330 as the output. The depth map 330 provides a pixel-wise depiction of depths within the image relative to the camera. Thus, with the characteristics of the salient object known from the language model, the control module 220 can compare the values within the depth map 330 with the salient object to determine a scaling factor that corrects the depth values to accurate metric depth values. The control module 220, in one approach, generates the scaling factor as a term within a loss calculation 560 of a loss function, resulting in the generation of a loss value 570. The loss value 570 can then be used to update the depth model 300 as part of training.

As a further explanation of the training architecture formed in relation to the depth model 300 and the pose model 400, further consider FIG. 2. The control module 220 generally includes instructions that function to control the processor 110 to execute various actions associated with the models 250. For example, in one embodiment, the control module 220 functions to execute the pose model 400 to produce the transformation 430, which functions as a basis for synthesizing an image from a generated depth map for determining, for example, photometric loss values of the loss 570. Accordingly, the control module 220 controls the depth model 300 to initially encode the source image into depth features. Thereafter, the control module 220 decodes the warped features into the depth map 300 and synthesizes the depth map 330 into an image using the transformation from the pose model 400. From the synthesized image the control module 220 generates the photometric loss as will be explained further subsequently.

In any case, the control module 220 synthesizes the depth values into an inferred form of the target image. As further explanation, consider the self-supervised loss context for structure from motion (SfM), which involves the control module 220 being generally configured with a goal of (i) a monocular depth model f_{D}: I→D (e.g., depth model 300), that predicts the scale-ambiguous depth \hat{D}=f_{D}(I(p)) for every pixel p in the target image Iₜ; and (ii) a monocular ego-motion estimator fₓ:(Iₜ, Iₛ) (e.g., pose model 400), that predicts the set of 6-DoF rigid-body transformations for all s∈S given by

$${x}_{t \to s} = ( \begin{matrix}R & t \\ 0 & 1\end{matrix} ) ∈ SE , \qquad ( 3 )$$

between the target image Iₜ and the set of source images Iₛ∈Iₛ considered as part of the temporal context. As a point of implementation, in one or more embodiments, the control module 220 uses various frames Iₜ₋₁ and Iₜ₊₁ as source images, although a larger context can be implemented in various arrangements (e.g., ±5 images). It should be appreciated that the source images relate to the target image (Iₜ) by depicting the same scene and via the transformations.

The control module 220, in at least one arrangement, implements the training objective for the depth model 300 according to various components. The components include a self-supervised term (e.g., photometric loss) that operates on appearance matching [symbol] ₚ between the target image Iₜ and a synthesized image I_{s→t} (also annotated as Îₜ) from the context set S={Iₛ}ₛ₌₁^{S}, which may further include masking Mₚ and depth smoothness [symbol] ₛₘₒₒₜₕ although a sampling process may avoid the use of masking and smoothness in at least one approach. In the present approach, the depth system 170 may also generate a scaling component [symbol] _{scale}.

$${p}_{} ( {I}_{t} , {\hat{I}}_{t} ) = {p}_{} ⊙ {p}_{} + {λ}_{1} {smooth}_{} + {λ}_{2} {scale}_{} \qquad ( 1 )$$

Mₚ is a binary mask that can be implemented to avoid computing the photometric loss on the pixels that do not have a valid mapping (e.g., pixels from the separate images that do not project onto the target image given the estimated depth). λ₁, λ₂ represent weights for adjusting the loss terms in eq (1). [symbol] ₚ represents appearance matching loss and is implemented according to, in one embodiment, a pixel-level similarity between the target image Iₜ and the synthesized image Îₜ using a structural similarity (SSIM) term combined with an L1 pixel-wise loss term inducing an overall photometric loss, as shown in equation (2).

$${p}_{} ( {I}_{t} , {\hat{I}}_{t} ) = α \frac{1 - SSIM ( {I}_{t} , {\hat{I}}_{t} )}{2} + ( 1 - α ) ‖ {I}_{t} - {\hat{I}}_{t} ‖ \qquad ( 2 )$$

While multi-view projective geometry provides strong cues for self-supervision, errors due to parallax and out-of-bounds objects have an undesirable effect incurred on the photometric loss that can include added noise to the training. Accordingly, in one or more approaches, the control module 220 can mitigate these effects by calculating the minimum photometric loss per pixel for the source image according to (3).

$${p}_{} ( {I}_{t} , S ) = {min}_{s ∈ S} {p}_{} ( {I}_{t} , {I}_{s \to t} ) \qquad ( 3 )$$

The intuition involves the same pixel not occluding or being out-of-bounds in all context images, and that the association with minimal photometric loss should be the correct association. The mask (Mₚ) removes pixels that have appearance loss that does not change between frames and that may be associated with various anomalies, which includes static scenes and dynamic objects moving at a similar speed as the camera.

$${M}_{p} = ( {min}_{s ∈ S} {p}_{} ( {I}_{t} , {I}_{s} ) > {min}_{s ∈ S} {p}_{} ( {I}_{t} , {I}_{s \to t} ) ) \qquad ( 4 )$$

[symbol] ₛₘₒₒₜₕ represents depth smoothness loss and is implemented to regularize the depth in textureless low-image gradient regions, as shown in equation (5). The smoothness loss is an edge-aware term that is weighted for separate pyramid levels starting from 1 and decaying by a factor of two for the separate scales.

$${s}_{} ( {\hat{D}}_{t} ) = \vert {δ}_{x} {\hat{D}}_{t} \vert {e}^{- \vert {δ}_{x} {I}_{t} \vert} + \vert {δ}_{y} {\hat{D}}_{t} \vert {e}^{- \vert {δ}_{y} {I}_{t} \vert} \qquad ( 5 )$$

Moreover, the scaling component [symbol] _{scale} represents a factor defining a difference between depth values within the depth map 330 in comparison to reference values derived from objects of known size. That is, the control module 220 may perform a direct comparison by correlating the physical features of the salient object provided by the language model 540 with depth values within the depth map associated with the same object or at least nearby objects. As a result, the control module 220 can determine a scaling factor that, in at least one approach, defines a ratio between the ground truth data associated with the salient object and the values in the depth map 330.

In any case, the control module 220, in one approach, calculates the loss 570, including the appearance-based loss according to the above to include the photometric loss, the mask, the depth smoothness, and the scaling terms for the self-supervised training. However, in various arrangements, one or more of the terms may not be included or further terms may be added. Moreover, in yet further approaches, the loss calculation may not be appearance-based but may instead rely on direct comparisons of depth maps. In any case, through this training, the depth model 300 develops a learned prior of the monocular images as embodied by the internal parameters of the model 300 from the training on the images. In general, the model 250 develops the learned understanding about how depth relates to various aspects of an image according to, for example, size, perspective, and so on.

It should be appreciated that the control module 220, in one or more configurations, trains the depth model 300 and the pose model 400 together in an iterative manner over the training data embodied by the images 240 that includes a plurality of monocular images from video. Through the process of training the model 300, the control module 220 adjusts various hyper-parameters in the depth model 300 to fine-tune the functional blocks included therein. Through this training process, the depth model 300 develops a learned prior of the monocular images as embodied by the internal parameters. In general, the depth model 300 develops the learned understanding about how depth relates to various aspects of an image according to, for example, size, perspective, and so on. Consequently, the control module 220 can provide the resulting trained depth model 300 in the depth system 170 to estimate depths from monocular images that do not include an explicit modality identifying the depths. In further aspects, the control module 220 may provide the depth model 300 to other systems that are remote from the depth system 170 once trained to perform similar tasks. In this way, the depth system 170 functions to improve the accuracy of the depth model 300.

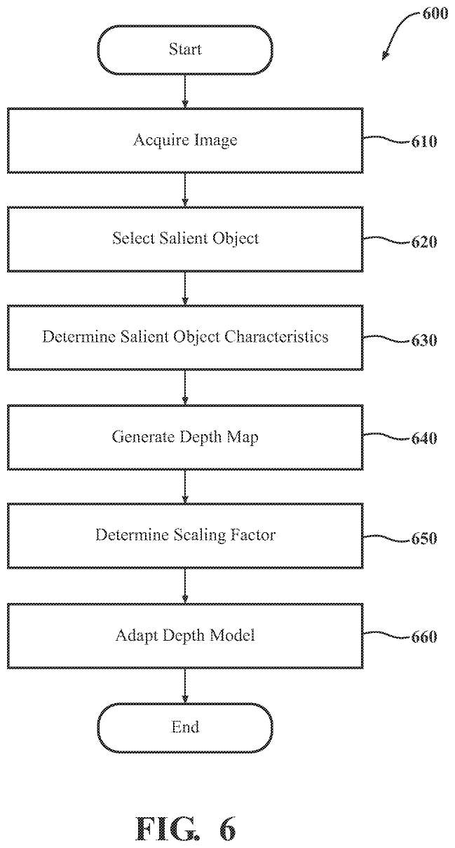

FIG. 6 illustrates a flowchart of a method 600 that is associated with using salient features to improve scale awareness in a depth model. Method 600 will be discussed from the perspective of the depth system 170. While method 600 is discussed in combination with the depth system 170, it should be appreciated that the method 600 is not limited to being implemented within the depth system 170 but is instead one example of a system that may implement the method 600.

At 610, the control module 220 acquires the images 240. As previously outlined, in the instance of training, the images 240 are derived from a monocular video for training and are grouped into sets such that a set of images are captured within a defined time of one another in order to depict a common scene. This is generally distinct from inference where the images 240 do not have an explicit relationship. In any case, as noted, the images 240 are monocular images having characteristics defined according to a camera and associated systems that capture the images 240. For separate iterations of the training process, the depth system 170, in one approach, uses pairs of training images that include a source image and a target image. In general, the control module 220 derives the warped depth map 260 using the source image, and the comparison for training occurs against the target image. However, in further aspects, the control module 220 may derive a depth map for both of the images depending on the way in which the depth system 170 implements the loss calculation.

In the instance of inference, the control module 220 actively acquires the image from the camera 126. That is, as one example, while the vehicle 100 is operating in an environment, the control module 220 is capturing the images 240, which the depth system 170 can then process according to the method 600 in order to, for example, maintain the accuracy/calibration of the camera.

At 620, the control module 220 selects a salient object from the surrounding objects depicted in the image. In one arrangement, the control module 220 initially processes the image using a semantic model that identifies surrounding objects depicted in the image. The semantic model may perform semantic segmentation or another approach to identifying the objects. In either case, the semantic model identifies at least a classification for each object depicted in the image (e.g., building, person, dog, vehicle, etc.). In a further embodiment, the control module 220 identifies particularities of the object, such as further identifying features, including vehicle make/model, sign type, etc. To select the salient object, the control module 220 further discriminates between the classifications of the objects identified therein. That is, the control module 220 identifies which of the objects are of known or standardized sizes. For example, if the semantic model identifies multiple people or animals, both of these classifications have a wide range of possible sizes, which greatly complicates determining accurate physical dimensions to use for comparison. By contrast, identifying a traffic sign, such as a yield sign, is an example of an object that is of a standard size. Accordingly, the control module 220 selects objects with known/standardized features as the salient objects. Other examples of salient objects include vehicles with known makes/models, infrastructure elements (e.g., fire hydrants), guardrails, traffic signs/lights, and so on.

In addition to determining a classification of the objects and selecting salient objects, the control module 220 may further segment the salient object from the surrounding objects. For example, once the control module 220 identifies an object as belonging to a defined group of classifications that are salient, the control module 220 may segment a representation of the object from the image and pair the representation with the classification information. In this way, the salient object can be further analyzed subsequently.

At 630, the control module 220 determines characteristics of the salient object(s). In one approach, the control module 220 uses a language model to analyze the information about the salient object in order to determine the characteristics. For example, the control module 220 may form a query that includes a representation of the salient object from the image and/or the classification derived by the semantic model. In either case, the control module 220, for example, forms the information into a text-based query to the language model. As one example, the control module 220 may formulate the query as “how wide is the stop sign?” Accordingly, language model accepts the query, which may also include the segmented or full image, and provides an answer in response that includes the requested information in the form of the characteristics. It should be appreciated that depending on the salient object and the particular implementation, the form of the query may vary.

Moreover, the particular form of the query may vary in relation to each separate classification in order to acquire accurate characteristics about the object. As a further example, the control module 220 may implement a predefined heuristic with different query templates for separate classifications that formulate the query differently. In further examples, the query may focus on dimensions overall, width, height, specific sub-components of an object, and so on.

At 640, the control module 220 generates a depth map for the image. In one approach, the control module 220 applies the depth model to the image to derive the depth map. The depth map provides a pixel-wise estimation of depth values with a scene depicted by the image.

At 650, the control module 220 determines a scaling factor. The scaling factor defines a relationship between known metric values associated with the salient object as defined via the characteristics and depth estimates within the depth map. Thus, the scaling factor may take different forms depending on the implementation but generally defines a ratio of the known to estimated values. To determine the scaling factor, the control module 220, in one approach, compares the characteristics with depth values. For example, the length of a vehicle as known from the characteristics, may be compared with the depth values to determine correspondence. In one configuration, this comparison may involve adapting the characteristics according to a pose of the vehicle with the scene to accurately match the known information with the depth values. Moreover, the depth system 170 may undertake this process for multiple different regions within the image as enabled according to the different salient objects that are present.

At 660, the control module 220 adapts the depth model according to the characteristics. As noted previously, the control module 220 may adapt the depth model either in relation to training through using the scaling factor as an additional term in the loss function and/or during inference as a way to adapt the depth map when generated. In either case, the scaling factor improves the accuracy of the depth model, thereby improving the functioning of systems that rely on the depth map.

The control model 220 can provide the depth model, once trained, by, for example, integrating the depth model in a perception pipeline of an autonomous vehicle to facilitate control of the autonomous vehicle. The control module 220 may further provide the depth model 300 upon completion of training, which may occur after a defined number of iterations of the training process over a plurality of images in a set of training data or according to a desired residual loss value from subsequent iterations of training. The resulting depth model 300 can then be implemented in the vehicle 100 to improve perception for various tasks. It should be appreciated that the control module 220 can provide an electronic output indicating depth within a perceived scene. As one example, the control module 220, in one approach, uses the outputs to map locations of obstacles in the surrounding environment and plan a trajectory that safely navigates the obstacles. Thus, the control module 220 may, in one embodiment, control the vehicle 100 to navigate through the surrounding environment according to the outputs of the depth model 300.

In further aspects, the control module 220 conveys the electronic outputs to further internal systems/components of the vehicle 100, such as the automated driving module 160. By way of example, in one arrangement, the control module 220 generates the depth map using the model 250 and conveys the electronic outputs to the automated driving module 160. In this way, the depth system 170 informs the automated driving module 160 of depth estimates, objects, and so on to improve situational awareness and planning of the module 160. It should be appreciated that the automated driving module 160 is indicated as one example, and, in further arrangements, the control module 220 may provide the outputs to the module 160 and/or other components in parallel or as a separate communication.

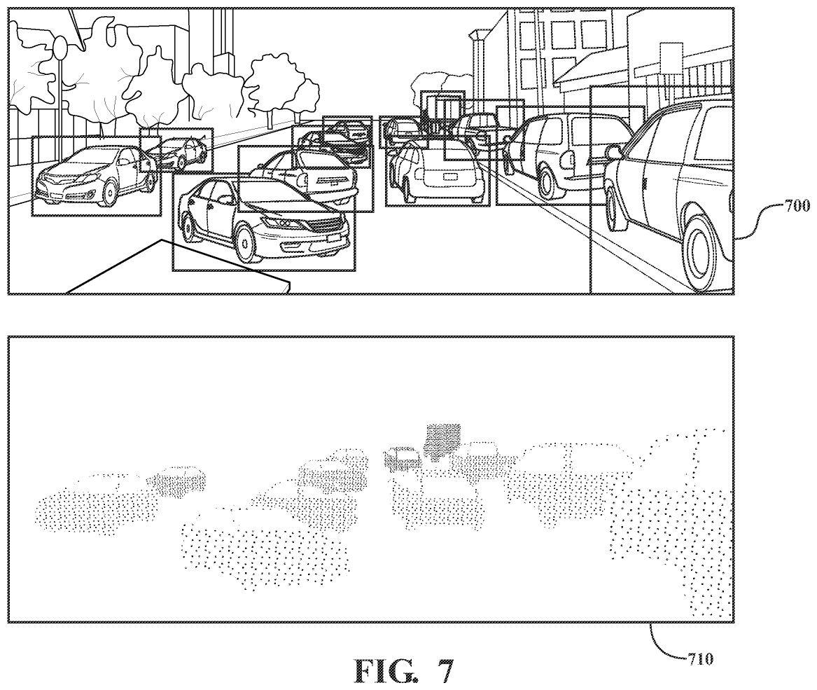

FIG. 7 illustrates one example of an image 700 that may be processed by the depth system 170. As shown, the depth system 170 identifies salient objects present within the image 700, which are marked via the bounding boxes. For these salient objects, the depth system 170 can then use the language model to determine characteristics or even 3D models of the objects and then use the characteristics/models as a point of comparison with depth estimates associated with the objects, as shown in 710. In this way, the depth system 170 is able to derive the scaling factor and improve the depth model to provide accurate metric values as the depth estimates.

FIG. 1 will now be discussed in full detail as an example environment within which the system and methods disclosed herein may operate. In some instances, the vehicle 100 is configured to switch selectively between an autonomous mode, one or more semi-autonomous operational modes, and/or a manual mode. Such switching can be implemented in a suitable manner, now known or later developed. “Manual mode” means that all of or a majority of the navigation and/or maneuvering of the vehicle is performed according to inputs received from a user (e.g., human driver). In one or more arrangements, the vehicle 100 can be a conventional vehicle that is configured to operate in only a manual mode.

In one or more embodiments, the vehicle 100 is an autonomous vehicle. As used herein, “autonomous vehicle” refers to a vehicle that operates in an autonomous mode. “Autonomous mode” refers to navigating and/or maneuvering the vehicle 100 along a travel route using one or more computing systems to control the vehicle 100 with minimal or no input from a human driver. In one or more embodiments, the vehicle 100 is highly automated or completely automated. In one embodiment, the vehicle 100 is configured with one or more semi-autonomous operational modes in which one or more computing systems perform a portion of the navigation and/or maneuvering of the vehicle along a travel route, and a vehicle operator (i.e., driver) provides inputs to the vehicle to perform a portion of the navigation and/or maneuvering of the vehicle 100 along a travel route.

The vehicle 100 can include one or more processors 110. In one or more arrangements, the processor(s) 110 can be a main processor of the vehicle 100. For instance, the processor(s) 110 can be an electronic control unit (ECU). The vehicle 100 can include one or more data stores 115 for storing one or more types of data. The data store 115 can include volatile and/or non-volatile memory. Examples of suitable data stores 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store 115 can be a component of the processor(s) 110, or the data store 115 can be operatively connected to the processor(s) 110 for use thereby. The term “operatively connected,” as used throughout this description, can include direct or indirect connections, including connections without direct physical contact.

In one or more arrangements, the one or more data stores 115 can include map data 116. The map data 116 can include maps of one or more geographic areas. In some instances, the map data 116 can include information or data on roads, traffic control devices, road markings, structures, features, and/or landmarks in the one or more geographic areas. The map data 116 can be in any suitable form. In some instances, the map data 116 can include aerial views of an area. In some instances, the map data 116 can include ground views of an area, including 360-degree ground views. The map data 116 can include measurements, dimensions, distances, and/or information for one or more items included in the map data 116 and/or relative to other items included in the map data 116. The map data 116 can include a digital map with information about road geometry. The map data 116 can be high quality and/or highly detailed.

In one or more arrangements, the map data 116 can include one or more terrain maps 117. The terrain map(s) 117 can include information about the ground, terrain, roads, surfaces, and/or other features of one or more geographic areas. The terrain map(s) 117 can include elevation data in the one or more geographic areas. The map data 116 can be high quality and/or highly detailed. The terrain map(s) 117 can define one or more ground surfaces, which can include paved roads, unpaved roads, land, and other things that define a ground surface.

In one or more arrangements, the map data 116 can include one or more static obstacle maps 118. The static obstacle map(s) 118 can include information about one or more static obstacles located within one or more geographic areas. A “static obstacle” is a physical object whose position does not change or substantially change over a period of time and/or whose size does not change or substantially change over a period of time. Examples of static obstacles include trees, buildings, curbs, fences, railings, medians, utility poles, statues, monuments, signs, benches, furniture, mailboxes, large rocks, hills. The static obstacles can be objects that extend above ground level. The one or more static obstacles included in the static obstacle map(s) 118 can have location data, size data, dimension data, material data, and/or other data associated with it. The static obstacle map(s) 118 can include measurements, dimensions, distances, and/or information for one or more static obstacles. The static obstacle map(s) 118 can be high quality and/or highly detailed. The static obstacle map(s) 118 can be updated to reflect changes within a mapped area.

The one or more data stores 115 can include sensor data 119. In this context, “sensor data” means any information about the sensors that the vehicle 100 is equipped with, including the capabilities and other information about such sensors. As will be explained below, the vehicle 100 can include the sensor system 120. The sensor data 119 can relate to one or more sensors of the sensor system 120. As an example, in one or more arrangements, the sensor data 119 can include information on one or more LIDAR sensors 124 of the sensor system 120.

In some instances, at least a portion of the map data 116 and/or the sensor data 119 can be located in one or more data stores 115 located onboard the vehicle 100. Alternatively, or in addition, at least a portion of the map data 116 and/or the sensor data 119 can be located in one or more data stores 115 that are located remotely from the vehicle 100.

As noted above, the vehicle 100 can include the sensor system 120. The sensor system 120 can include one or more sensors. “Sensor” means any device, component, and/or system that can detect, and/or sense something. The one or more sensors can be configured to detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors can work independently from each other. Alternatively, two or more of the sensors can work in combination with each other. In such a case, the two or more sensors can form a sensor network. The sensor system 120 and/or the one or more sensors can be operatively connected to the processor(s) 110, the data store(s) 115, and/or another element of the vehicle 100 (including any of the elements shown in FIG. 1). The sensor system 120 can acquire data of at least a portion of the external environment of the vehicle 100.

The sensor system 120 can include any suitable type of sensor. Various examples of different types of sensors will be described herein. However, it will be understood that the embodiments are not limited to the particular sensors described. The sensor system 120 can include one or more vehicle sensors 121. The vehicle sensor(s) 121 can detect, determine, and/or sense information about the vehicle 100 itself. In one or more arrangements, the vehicle sensor(s) 121 can be configured to detect, and/or sense position and orientation changes of the vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a global positioning system (GPS), a navigation system 147, and/or other suitable sensors. The vehicle sensor(s) 121 can be configured to detect, and/or sense one or more characteristics of the vehicle 100. In one or more arrangements, the vehicle sensor(s) 121 can include a speedometer to determine a current speed of the vehicle 100.

Alternatively, or in addition, the sensor system 120 can include one or more environment sensors 122 configured to acquire, and/or sense driving environment data. “Driving environment data” includes data or information about the external environment in which an autonomous vehicle is located or one or more portions thereof. For example, the one or more environment sensors 122 can be configured to detect, quantify and/or sense obstacles in at least a portion of the external environment of the vehicle 100 and/or information/data about such obstacles. Such obstacles may be stationary objects and/or dynamic objects. The one or more environment sensors 122 can be configured to detect, measure, quantify and/or sense other things in the external environment of the vehicle 100, such as, for example, lane markers, signs, traffic lights, traffic signs, lane lines, crosswalks, curbs proximate the vehicle 100, off-road objects, etc.

Various examples of sensors of the sensor system 120 will be described herein. The example sensors may be part of the one or more environment sensors 122 and/or the one or more vehicle sensors 121. However, it will be understood that the embodiments are not limited to the particular sensors described.

As an example, in one or more arrangements, the sensor system 120 can include one or more radar sensors 123, one or more LIDAR sensors 124 (e.g., 4 beam LiDAR), one or more sonar sensors 125, and/or one or more cameras 126. In one or more arrangements, the one or more cameras 126 can be high dynamic range (HDR) cameras or infrared (IR) cameras.

The vehicle 100 can include an input system 130. An “input system” includes any device, component, system, element or arrangement or groups thereof that enable information/data to be entered into a machine. The input system 130 can receive an input from a vehicle passenger (e.g., a driver or a passenger). The vehicle 100 can include an output system 135. An “output system” includes a device, or component, that enables information/data to be presented to a vehicle passenger (e.g., a person, a vehicle passenger, etc.).

The vehicle 100 can include one or more vehicle systems 140. Various examples of the one or more vehicle systems 140 are shown in FIG. 1. However, the vehicle 100 can include more, fewer, or different vehicle systems. It should be appreciated that although particular vehicle systems are separately defined, each or any of the systems or portions thereof may be otherwise combined or segregated via hardware and/or software within the vehicle 100. The vehicle 100 can include a propulsion system 141, a braking system 142, a steering system 143, throttle system 144, a transmission system 145, a signaling system 146, and/or a navigation system 147. Each of these systems can include one or more devices, components, and/or a combination thereof, now known or later developed.

The navigation system 147 can include one or more devices, applications, and/or combinations thereof, now known or later developed, configured to determine the geographic location of the vehicle 100 and/or to determine a travel route for the vehicle 100. The navigation system 147 can include one or more mapping applications to determine a travel route for the vehicle 100. The navigation system 147 can include a global positioning system, a local positioning system, or a geolocation system.

The processor(s) 110, the depth system 170, and/or the automated driving module 160 can be operatively connected to communicate with the various vehicle systems 140 and/or individual components thereof. For example, returning to FIG. 1, the processor(s) 110 and/or the automated driving module 160 can be in communication to send and/or receive information from the various vehicle systems 140 to control the movement, speed, maneuvering, heading, direction, etc. of the vehicle 100. The processor(s) 110, the depth system 170, and/or the automated driving module 160 may control some or all of these vehicle systems 140 and, thus, may be partially or fully autonomous.

The processor(s) 110, the depth system 170, and/or the automated driving module 160 can be operatively connected to communicate with the various vehicle systems 140 and/or individual components thereof. For example, returning to FIG. 1, the processor(s) 110, the depth system 170, and/or the automated driving module 160 can be in communication to send and/or receive information from the various vehicle systems 140 to control the movement, speed, maneuvering, heading, direction, etc. of the vehicle 100. The processor(s) 110, the depth system 170, and/or the automated driving module 160 may control some or all of these vehicle systems 140.

The processor(s) 110, the depth system 170, and/or the automated driving module 160 may be operable to control the navigation and/or maneuvering of the vehicle 100 by controlling one or more of the vehicle systems 140 and/or components thereof. For instance, when operating in an autonomous mode, the processor(s) 110, the depth system 170, and/or the automated driving module 160 can control the direction and/or speed of the vehicle 100. The processor(s) 110, the depth system 170, and/or the automated driving module 160 can cause the vehicle 100 to accelerate (e.g., by increasing the supply of fuel provided to the engine), decelerate (e.g., by decreasing the supply of fuel to the engine and/or by applying brakes) and/or change direction (e.g., by turning the front two wheels). As used herein, “cause” or “causing” means to make, force, compel, direct, command, instruct, and/or enable an event or action to occur or at least be in a state where such event or action may occur, either in a direct or indirect manner.

The vehicle 100 can include one or more actuators 150. The actuators 150 can be any element or combination of elements operable to modify, adjust and/or alter one or more of the vehicle systems 140 or components thereof responsive to receiving signals or other inputs from the processor(s) 110 and/or the automated driving module 160. Any suitable actuator can be used. For instance, the one or more actuators 150 can include motors, pneumatic actuators, hydraulic pistons, relays, solenoids, and/or piezoelectric actuators, just to name a few possibilities.

The vehicle 100 can include one or more modules, at least some of which are described herein. The modules can be implemented as computer-readable program code that, when executed by a processor 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processor(s) 110. Alternatively, or in addition, one or more data store 115 may contain such instructions.

In one or more arrangements, one or more of the modules described herein can include artificial or computational intelligence elements, e.g., neural network, fuzzy logic, or other machine learning algorithms. Further, in one or more arrangements, one or more of the modules can be distributed among a plurality of the modules described herein. In one or more arrangements, two or more of the modules described herein can be combined into a single module.

The vehicle 100 can include one or more autonomous driving modules 160. The automated driving module 160 can be configured to receive data from the sensor system 120 and/or any other type of system capable of capturing information relating to the vehicle 100 and/or the external environment of the vehicle 100. In one or more arrangements, the automated driving module 160 can use such data to generate one or more driving scene models. The automated driving module 160 can determine a position and velocity of the vehicle 100. The automated driving module 160 can determine the location of obstacles, obstacles, or other environmental features including traffic signs, trees, shrubs, neighboring vehicles, pedestrians, etc.

The automated driving module 160 can be configured to receive, and/or determine location information for obstacles within the external environment of the vehicle 100 for use by the processor(s) 110, and/or one or more of the modules described herein to estimate position and orientation of the vehicle 100, vehicle position in global coordinates based on signals from a plurality of satellites, or any other data and/or signals that could be used to determine the current state of the vehicle 100 or determine the position of the vehicle 100 with respect to its environment for use in either creating a map or determining the position of the vehicle 100 in respect to map data.

The automated driving module 160 either independently or in combination with the depth system 170 can be configured to determine travel path(s), current autonomous driving maneuvers for the vehicle 100, future autonomous driving maneuvers and/or modifications to current autonomous driving maneuvers based on data acquired by the sensor system 120, driving scene models, and/or data from any other suitable source. “Driving maneuver” means one or more actions that affect the movement of a vehicle. Examples of driving maneuvers include: accelerating, decelerating, braking, turning, moving in a lateral direction of the vehicle 100, changing travel lanes, merging into a travel lane, and/or reversing, just to name a few possibilities. The automated driving module 160 can be configured to implement determined driving maneuvers. The automated driving module 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The automated driving module 160 can be configured to execute various vehicle functions and/or to transmit data to, receive data from, interact with, and/or control the vehicle 100 or one or more systems thereof (e.g., one or more of vehicle systems 140).

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-7, but the embodiments are not limited to the illustrated structure or application.

The flowcharts and block diagrams in the Figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, module, as used herein, includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A depth system, comprising:
one or more processors;
a memory communicably coupled to the one or more processors and storing instructions that, when executed by the one or more processors, cause the one or more processors to:
acquire an image depicting surrounding objects present in an environment;
select a salient object from the surrounding objects;
determine characteristics of the salient object according to a language model; and
adapt a depth model according to the characteristics.

2. The depth system of claim 1, wherein the instructions to adapt the depth model include the instructions to train the depth model by using the characteristics to derive a scaling factor as a loss value that is part of a loss function, and
wherein the depth model performs monocular depth estimation and is trained according to self-supervised structure-from-motion (SfM) training.

3. The depth system of claim 1, wherein the instructions to adapt the depth model include instructions to use the characteristics to define a scaling factor for adapting depth values generated by the depth model during inference.

4. The depth system of claim 1, wherein the instructions to select the salient object include instructions to:
i) identify the surrounding objects according to a semantic model, and
ii) segment the salient object from the surrounding objects according to whether a class of the surrounding objects is one of a group of salient classifications.

5. The depth system of claim 1, wherein the instructions to determine the characteristics of the salient object include instructions to provide a representation of the salient object from the image to the language model that uses information about the salient object to determine the characteristics indicating at least a size of the salient object.

6. The depth system of claim 1, wherein the language model is one of a large language model (LLM) and a visual language model (VLM), and wherein the depth model performs monocular depth estimation on monocular images to generate depth data for the environment.

7. The depth system of claim 1, wherein the instructions further include instructions to:
provide the depth model, including integrating the depth model in a perception pipeline of an autonomous vehicle to facilitate control of the autonomous vehicle.

8. The depth system of claim 1, wherein the depth system is embedded within a vehicle to perceive depth in the environment.

9. A non-transitory computer-readable medium including instructions that, when executed by one or more processors, cause the one or more processors to:
acquire an image depicting surrounding objects present in an environment;
select a salient object from the surrounding objects;
determine characteristics of the salient object according to a language model; and
adapt a depth model according to the characteristics.

10. The non-transitory computer-readable medium of claim 9, wherein the instructions to adapt the depth model include the instructions to train the depth model by using the characteristics to derive a scaling factor as a loss value that is part of a loss function, and
wherein the depth model performs monocular depth estimation and is trained according to self-supervised structure-from-motion (SfM) training.

11. The non-transitory computer-readable medium of claim 9, wherein the instructions to adapt the depth model include instructions to use the characteristics to define a scaling factor for adapting depth values generated by the depth model during inference.

12. The non-transitory computer-readable medium of claim 9, wherein the instructions to select the salient object include instructions to:
i) identify the surrounding objects according to a semantic model, and
ii) segment the salient object from the surrounding objects according to whether a class of the surrounding objects is one of a group of salient classifications.

13. The non-transitory computer-readable medium of claim 9, wherein the instructions to determine the characteristics of the salient object include instructions to provide a representation of the salient object from the image to the language model that uses information about the salient object to determine the characteristics indicating at least a size of the salient object.

14. A method, comprising:
acquiring an image depicting surrounding objects present in an environment;
selecting a salient object from the surrounding objects;
determining characteristics of the salient object according to a language model; and
adapting a depth model according to the characteristics.

15. The method of claim 14, wherein adapting the depth model includes training the depth model by using the characteristics to derive a scaling factor as a loss value that is part of a loss function, and
wherein the depth model performs monocular depth estimation and is trained according to self-supervised structure-from-motion (SfM) training.

16. The method of claim 14, wherein adapting the depth model includes using the characteristics to define a scaling factor for adapting depth values generated by the depth model during inference.

17. The method of claim 14, wherein selecting the salient object includes:
i) identifying the surrounding objects according to a semantic model,
ii) segmenting the salient object from the surrounding objects according to whether a class of the surrounding objects is one of a group of salient classifications.

18. The method of claim 14, wherein determining the characteristics of the salient object includes providing a representation of the salient object from the image to the language model that uses information about the salient object to determine the characteristics indicating at least a size of the salient object.

19. The method of claim 14, wherein the language model is one of a large language model (LLM) and a visual language model (VLM), and wherein the depth model performs monocular depth estimation on monocular images to generate depth data for the environment.

20. The method of claim 14, further comprising:
providing the depth model, including integrating the depth model in a perception pipeline of an autonomous vehicle to facilitate control of the autonomous vehicle.
